(19) United States
(12) Patent Application Publication
(10) Pub. No.: US 2023/0178998 A1
(43) Pub. Date: Jun. 8, 2023

(54) Wireless Transceiver For Rechargeable Electronic Devices

(71) Applicant: Ossia Inc., Redmond, WA (US)

(72) Inventor: Hatem Ibrahim Zeine, Woodinville, WA (US)

(21) Appl. No.: 18/061,267

(22) Filed: Dec. 2, 2022

Related U.S. Application Data
(60) Provisional application No. 63/308,100, filed on Feb. 9, 2022.
(60) Provisional application No. 63/285,095, filed on Dec. 2, 2021.

(51) Int. Cl. H02J 7/00; H02J 50/10

(52) U.S. Cl. CPC H02J 7/00045; H02J 50/10; H02J 7/00041; H02J 7/00714

(57) ABSTRACT

Wireless transceivers, and associated methods and computer-readable media, for enabling wireless power signals to be used for operating and/or charging a battery of existing or newly designed rechargeable electronic devices. A method making use of the wireless transceivers according to the present technology may include the step determining, by a circuit, whether or not an output power associated with a voltage induced in response to the circuit receiving a wireless power signal meets a power requirement of another circuit coupled to the circuit. When the output power meets the power requirement, a first current may be transmitted from the circuit to the another circuit and the battery coupled to the circuit. Alternatively, when the output power does not meet the power requirement, a second current may be transmitted from the circuit to the another circuit, and a third current may be transmitted from the battery to the another circuit.

### CROSS-REFERENCE TO RELATED APPLICATIONS

This application claims the benefit of U.S. Provisional Patent Application No. 63/308,100 filed Feb. 9, 2022, and U.S. Provisional Patent Application No. 63/285,095 filed Dec. 2, 2021, each of which is incorporated by reference herein in its entirety.

### BACKGROUND

A wide variety of rechargeable electronic devices are in use at present by industry and consumers. Users rely to a large extent on the availability of wall or vehicle power outlets for charging batteries of these devices. Wireless power-based charging systems may enhance both the reliability and user experience for rechargeable electronic devices in a large number of specialized, as well as every day, use cases.

Testing and integration of wireless power receivers into existing and new designs for rechargeable electronic devices may be challenging and may thus slow the adaptation of wireless power charging in both industrial and consumer product markets. A similar roadmap and timeline were experienced with Wi-Fi Internet connectivity in laptop computers. Initially, with no laptops having built-in Wi-Fi transceivers, wireless Internet could only be provided with a PCMCIA card and appropriate driver software. Later, wireless Internet functionality could be had in laptops as an optional feature, whereby a component similar to the Wi-Fi PCMCIA card was built into the main housing of the device, rather than being inserted by a user into a slot. Presently, most all laptop computers have all the necessary hardware and software already installed for Wi-Fi wireless Internet, and indeed many laptops today may only connect to the Internet as such, where wired connections (e.g., Ethernet cord) may not be available except by a user adaptation with some additional hardware feature.

Accordingly, a need exists for technology that overcomes the problem demonstrated above, as well as one that provides additional benefits. The examples provided herein of some prior or related devices, systems and methods, and their associated limitations, are intended to be illustrative and not exclusive. Other limitations of existing or prior systems will become apparent to those of skill in the art upon reading the following detailed description.

### SUMMARY

Wireless transceivers, and associated methods, processes and computer-readable media according to the present technology enable wireless power signals to be used for operating and/or charging a battery of existing or newly designed rechargeable electronic devices. The disclosed embodiments of devices, systems, processes, methods, and software or firmware can speed the advantageous adaptation of wireless power signal-based operation of a wide array of rechargeable electronic devices.

In certain embodiments, an apparatus may include a circuit configured to: receive a wireless power signal, and induce a voltage in response to the circuit receiving the wireless power signal. The apparatus may also include a controller coupled to the circuit. The controller may be configured to determine whether or not an output power associated with the induced voltage is greater than or equal to a power requirement of another circuit for coupling to the circuit. For the output power being determined by the controller to be greater than or equal to the power requirement, the controller may be further configured to cause a first current to be transmitted from the circuit to the another circuit and an energy storage device for coupling to the circuit. Alternatively, for the output power being determined by the controller to be less than the power requirement, the controller may be further configured to: cause a second current to be transmitted from the circuit to the another circuit, and cause a third current to be transmitted from the energy storage device to the another circuit.

In certain embodiments, a method may include the step determining, by a first circuit, whether or not an output power associated with a voltage induced in response to the first circuit receiving a wireless power signal is greater than or equal to a power requirement of a second circuit coupled to the first circuit. When it is determined that the output power is greater than or equal to the power requirement, the method may include the step of transmitting a first current from the first circuit to the second circuit and an energy storage device coupled to the first circuit. Alternatively, when it is determined that the output power is less than the power requirement, the method may include the steps of: transmitting a second current from the first circuit to the second circuit, and transmitting a third current from the energy storage device to the second circuit.

In certain embodiments, one or more non-transitory computer readable media can have stored thereon instructions which, when executed by at least one processor, cause a machine to determine whether or not an output power associated with a voltage induced in response to a first circuit receiving a wireless power signal is greater than or equal to a power requirement of a second circuit coupled to the first circuit. When the machine determines that the output power is greater than or equal to the power requirement, the program instructions further cause the machine to cause the first circuit to transmit a first current to the second circuit and an energy storage device coupled to the first circuit. Alternatively, when the machine determines that the output power is less than the power requirement, the program instructions further cause the machine to: transmit a second current to the second circuit, and transmit a third current from the energy storage device to the second circuit.

The embodiments of the present technology as shown, described and claimed herein provide circuitry and control schemes therefor provide at least the following advantageous technical effects: (a) a wireless transceiver that may be either retrofitted into existing rechargeable electronic devices, or integrated de novo into new designs, to enable radio frequency (RF) wireless power signals to be used for operation and battery charging; (b) the wireless transceiver includes a circuit that can receive, relay, and apportion electric currents from multiple different DC electric power sources—including ones derived from wireless power signals—for use in operating the rechargeable electronic device and charging its battery or batteries; (c) a wireless transceiver that may be powered by either the existing power sources used by the rechargeable electronic device, or additionally or instead by wireless power signals; (d) a wireless transceiver having a size that may facilitate insertion into housings of existing rechargeable electronic devices and which may be formed, at least in part, as a flexible printed circuit board (PCB); (e) a wireless transceiver having circuitry controlled such that the wireless transceiver coupled to and between circuit(s) of the rechargeable electronic device and at least one battery thereof emulates the at least one battery with no requirement for modification of either the existing circuit(s) or battery(ies) of the device, and existing software or firmware of the device; and (f) such other(s) that may be readily understood and appreciated, upon study of the present disclosure, by persons having ordinary skill in the art.

### BRIEF DESCRIPTION OF THE DRAWINGS

FIG. 1 is a block diagram of a wireless power delivery environment, in accordance with certain embodiments of the present disclosure.

FIG. 2 is a block diagram of a wireless power transmission system, in accordance with certain embodiments of the present disclosure.

FIG. 3 is a circuit diagram of a rechargeable electronic device, in accordance with an embodiment known in the prior art.

FIG. 4 is a circuit diagram of a wireless transceiver, in accordance with certain embodiments of the present disclosure.

FIGS. 5A-5H are circuit diagrams of a junction circuit that may be used with the wireless transceiver shown in FIG. 4, and operational states thereof, in accordance with certain embodiments of the present disclosure.

FIG. 6 is a sequence diagram illustrating example operations between a wireless power transmission system and a wireless transceiver, in accordance with certain embodiments of the present disclosure.

FIG. 7 is a state diagram of a process for operating a wireless transceiver, in accordance with certain embodiments of the present disclosure.

FIG. 8 is a flowchart of a method of operating a wireless transceiver, in accordance with certain embodiments of the present disclosure.

FIG. 9 is a block diagram of a computing device with a wireless power receiver, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, system-on-chip (SoC), circuit logic, and other hardware devices can likewise be constructed to implement the circuits, functions, processes, and methods described herein. Methods and functions may be performed by modules or engines, both of which may include one or more physical components of a computing device (e.g., logic, circuits, processors, controllers, etc.) configured to perform a particular task or job, or may include instructions that, when executed, can cause a processor to perform a particular task or job, or may be any combination thereof. Further, the methods described herein may be implemented as a computer readable storage medium or memory device including instructions that, when executed, cause a processor to perform the methods.

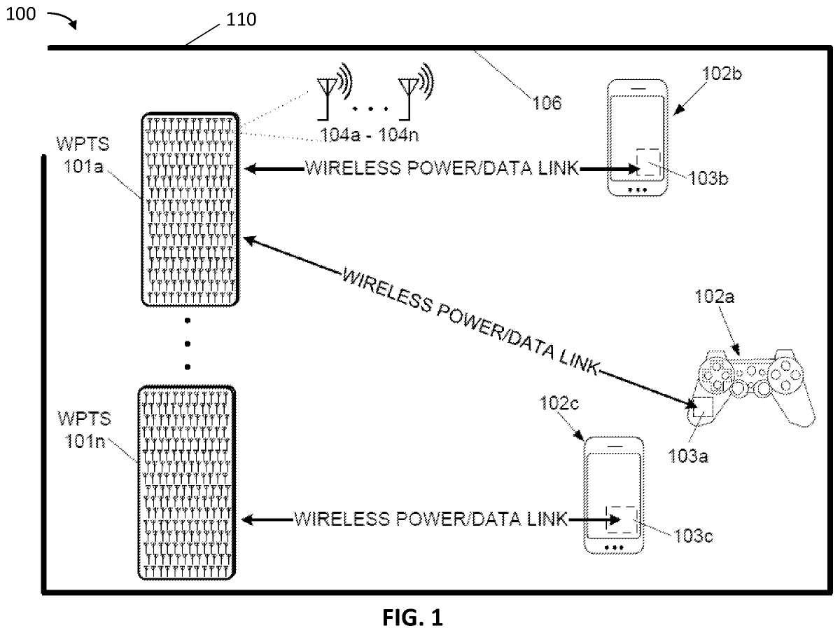

Referring to FIG. 1, a block diagram of a wireless power delivery environment is shown and generally designated 100. The environment 100 can provide wireless power delivery from one or more wireless power transmission systems (WPTS) 101a-n (also referred to as “wireless power delivery systems”, “antenna array systems” and “wireless chargers”) to various rechargeable electronic devices, such as device 102a, 102b, or 102c within the wireless power delivery environment 100, that have one or more wireless power transfer circuits 103a, 103b, or 103c (also referred to herein as a “client”, “wireless power receiver”, and the plural variations thereof). The wireless power receivers are configured to receive and process wireless power from one or more wireless power transmission systems 101a-101n.

As shown in the example of FIG. 1, the rechargeable electronic devices 102a-102n may include devices such as mobile phones, television remote controls, or wireless game controllers. Further, the rechargeable electronic devices 102a-102c can be any device or system that can receive power via a wireless power receiver (such as 103a, 103b, or 103c).

Each wireless power transmission system 101 can include multiple antennas 104a-n (e.g., an antenna array including hundreds or thousands of antennas), which are capable of delivering wireless power to wireless devices 102a-102c. In some embodiments, the antennas are adaptively-phased RF antennas. The wireless power transmission system 101 is capable of determining the appropriate phases with which to deliver a coherent power transmission signal to the wireless power receivers 103a-103c. The array is configured to emit a signal (e.g., continuous wave or pulsed power transmission signal) from multiple antennas at a specific phase relative to each other. It is appreciated that use of the term “array” does not necessarily limit the antenna array to any specific array structure. That is, the antenna array does not need to be structured in a specific “array” form or geometry. Furthermore, as used herein the term “array” or “array system” may include related and peripheral circuitry for signal generation, reception, and transmission, such as radios, digital logic, and modems. In some embodiments, the WPTS 101 can have an embedded Wi-Fi hub for data communications via one or more antennas or transceivers.

As illustrated in the example of FIG. 1, WPTS 101a-101n can each have multiple power delivery antennas, such as power deliver antennas 104a-104n in WPTS 101a. The power delivery antennas 104a can be configured to provide delivery of wireless radio frequency (RF) power in the wireless power delivery environment 100. In some embodiments, one or more of the power delivery antennas 104a-104n can alternatively or additionally be configured for data communications in addition to or in lieu of wireless power delivery. The one or more data communication antennas can be configured to send data communications to and receive data communications from the wireless power receivers 103a-103c, the rechargeable electronic devices 102a-102c, or a combination thereof. Such data communications may be implemented via any wireless data communication technology.

Each wireless power receiver 103a-103c can include one or more antennas (not shown) for receiving signals from the wireless power transmission systems 101a-101n. Likewise, each wireless power transmission system 101a-101n includes an antenna array having one or more antennas or sets of antennas capable of emitting continuous wave or discrete (pulse) signals at specific phases relative to each other. Each of the wireless power transmission systems 101a-101n is capable of determining the appropriate phases for delivering the coherent signals to the wireless power receivers 103a-103c. For example, in some embodiments, coherent signals can be determined by computing the complex conjugate of a received beacon (or calibration) signal at each antenna of the array such that the coherent signal is phased for delivering power to the particular wireless power receiver that transmitted the beacon (or calibration) signal.

Although not illustrated, each component of the environment, e.g., rechargeable electronic device, wireless power transmission system, etc., can include control and synchronization mechanisms, e.g., a data communication synchronization module. The WPTS 101a-101n can be connected to a power source such as, for example, a power outlet or source connecting the wireless power transmission systems to a standard or primary AC power supply in a building. Alternatively, or additionally, one or more of the WPTS 101a-101n can be powered by a battery or via other mechanisms, e.g., solar cells, etc.

The wireless power receivers 103a-103c and the wireless power transmission systems 101a-101n can be configured to operate in a multipath wireless power delivery environment 100. That is, the wireless power receivers 103a-103c and the WPTS 101a-101n can be configured to utilize a reflective object(s) 106 such as, for example, walls or other RF reflective obstructions within range to transmit beacon (or calibration) signals, receive wireless power, or receive data within the wireless power delivery environment 100. The reflective object(s) 106 can be utilized for multi-directional signal communication regardless of whether an object is blocking the line of sight between a WPTS 101 and the wireless power receivers 103.

As described herein, each rechargeable electronic device 102a-102c can be any system, device, or any combination thereof that can establish a connection with another device, a server, or other systems within the environment 100. In some embodiments, the rechargeable electronic devices 102a-102c can include displays or other output functionalities to present data to a user, include input functionalities to receive data from the user, or both. By way of example, a rechargeable electronic device 102 can be, but is not limited to, a video game controller, a server, a desktop computer, a computer cluster, a mobile computing device such as a notebook, a laptop computer, a handheld computer, a mobile phone, a smart phone, computer peripherals like a wireless mouse or wireless keyboard, an appliance, an alarm, a clock, a video doorbell, a toy, a surveillance or security system component, or similar. By way of example and not limitation, the rechargeable electronic device 102 can also be any wearable electronic device such as a watch, necklace, ring, or other electronic device embedded on or within a customer. Other examples of a rechargeable electronic device 102 include, but are not limited to, safety sensors (e.g., fire or carbon monoxide), electric toothbrushes, electric shavers or hair clippers, electronic door locks and handles, electric light switch controllers, electric shavers, etc.

The WPTS 101 and the wireless power receivers 103a-103c can each include a data communication module for communication via a data channel. Alternatively, or additionally, the wireless power receivers 103a-103c can direct the rechargeable electronic devices 102a-102c to communicate with the wireless power transmission system via a respective data communication module.

The wireless power receivers 103a-103c can implement a dual-band technique where a first band can be used as a dedicated retrodirective wireless power transfer (WPT) channel while a second band can be used as a communication channel. For example, a communication channel (node) can implement a low energy compatible communication type, such as Bluetooth Low Energy (BLE).

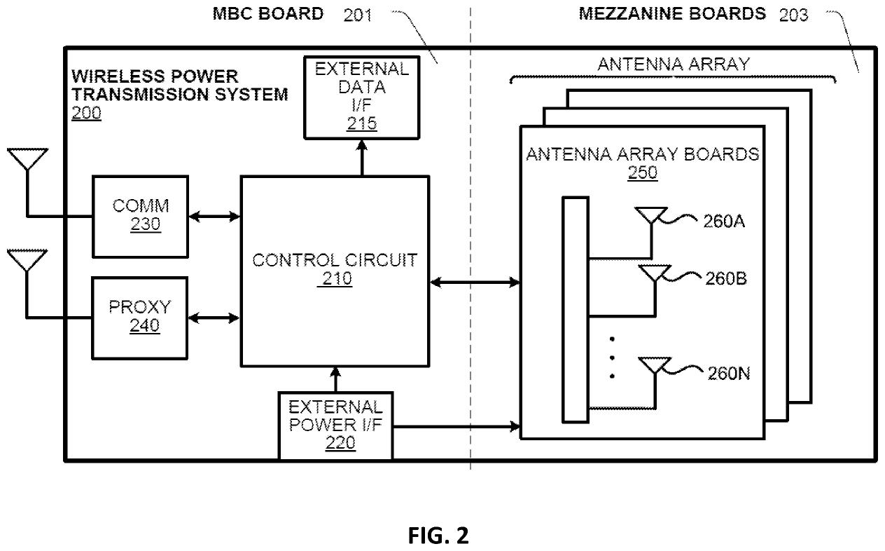

FIG. 2 depicts a block diagram of a wireless power transmission system 200, in accordance with certain embodiments of the present disclosure. The wireless power transmission system 200 may also be referred to herein as a wireless power delivery system or wireless power transmitter (WPT). The wireless power delivery system 200 can include one or more circuit boards, such as printed circuit boards (PCBs), which may include a master bus controller (MBC) board 201 and multiple mezzanine boards 203 that include the antenna array boards 250. The MBC board 201 can include control circuit 210, an external data interface (I/F) 215, an external power interface (I/F) 220, a communication block 230 and proxy 240. The mezzanine boards 203 (or antenna array boards 250) can each include multiple power transmission antennas 260A-260N. Some or all of the components of MBC board 201 or the mezzanine boards 203 can vary in quantity or be omitted in some embodiments; further, additional components can also be added. For example, in some embodiments only one of communication block 230 and proxy 240 may be included.

The control circuit 210 (or more succinctly “controller” 210) can be implemented via hardware circuits (e.g., application specific integrated circuits (ASICs), logic circuits, software, computer(s), microprocessor(s), microcontroller(s), field programmable gate array(s), or any combination thereof, and can be configured to provide control and intelligence to the components of the MBC board 201 as well as to the mezzanine boards 203. The control circuit 210 may include one or more processors, field programmable gate arrays (FPGAs), memory units, interface circuits, etc., and may direct and control the various data and power communications capabilities of the wireless power delivery system 200. The communication block 230 can direct data communications on a data carrier frequency, such as a base clock signal for clock synchronization. Likewise, the proxy block 240 can communicate with clients via data communications as discussed herein. In certain embodiments, any of the data communications herein can be implemented via any short-range wireless technology, such as Bluetooth™, Wi-Fi™, ZigBee™, etc., including combinations or variations thereof. In further embodiments, the data communications can be implemented via a low-power communication protocol, low-bandwidth communication protocol, or a protocol providing both low-power and low-bandwidth.

In some embodiments, the control circuit 210 can also facilitate or otherwise enable data aggregation for devices, such as for Internet of Things (IoT) devices. In some embodiments, wireless power receivers (e.g., 103) can access, track, or otherwise obtain IoT information about the device in which the wireless power receiver is embedded and provide that IoT information to the wireless power transmission system 300 over a data connection. This IoT information can be provided to a data collection system (not shown), which may be local or server-based on an intranet (e.g., private network) or extranet (e.g., internet cloud-based), via the external data interface 215, where the data can be aggregated, processed, or otherwise utilized. For example, the data collection system can process the data it receives to identify trends across various factors, such as geographies, wireless power transmission systems, environments, devices, etc. In some embodiments, the aggregated data or trend data determined from the aggregated data can be used to improve operation of the devices via remote updates or other updates. Alternatively, or additionally, in some embodiments, the aggregated data can be provided to third party data consumers. In a specific example, the wireless power transmission system can act as a gateway or enabler for IoT devices; the IoT information could include information regarding capabilities of the device in which the wireless power receiver is embedded, usage information of the device, power levels of the device, information obtained by the device or the wireless power receiver itself (e.g., via sensors, etc.), or any combination thereof.

The external power interface 220 can be configured to receive external power and provide the power to various components of the wireless power delivery system 200. In some embodiments, the external power interface 220 may be configured to receive an external direct current (DC) power supply. In other embodiments, the external power interface 220 can receive alternating current (AC) power and convert it to DC power via an embedded AC/DC converter circuit. Alternative configurations are also possible based on the power requirements of the wireless power delivery system 200.

In operation, the MBC board 201 can control the wireless power transmission system 200 when it receives power from a power source and is activated. The MBC board 201 may then activate one or more of the power transmission antenna elements 260A-260N, where the activated power transmission antenna elements 260A-260N can enter a default discovery mode to identify available wireless power receivers (e.g., 103a, 103b, or 103c) within range of the wireless power transmission system 200. When a wireless power receiver 103 is found, the activated antenna elements 260A-260N can power on, enumerate, and (optionally) calibrate. The control circuit 210, another circuit within the MBC board 201, or a combination thereof may determine when a radio frequency (RF) signal (e.g., beacon signal) is detected from a transmitter or transceiver of rechargeable electronic device 102. For example, a detection circuit or module of the MBC board 201 can detect a beacon signal transmitter from a wireless power receiver 103 embedded in or otherwise associated with the rechargeable electronic device 102 at a predetermined time and/or frequency. Such a beacon signal may prompt the wireless power delivery system 200 to initiate processes resulting in a wireless power signal being transmitted to the wireless power receiver 103 to facilitate charging an energy storage device (e.g., Li-ion or NiMH battery) of the rechargeable electronic device 102, such as discussed below.

The MBC board 201 can generate a discovery signal via the antenna array boards 250. The discovery signal may also be referred to as an activation signal or interrogation signal. In some embodiments, the discovery signal can be a pulse train modulated signal or a low-level interrogation signal. Generally, the discovery signal questions (or interrogates) the space for wireless power receivers 103, and a receiver 103 within the space may answer (or reply) via a beacon signal, for example.

The WPT system 200 can monitor one or more antennas, such as the antennas 260A-260N or a dedicated antenna, to detect a beacon signal from a wireless power receiver 103. Once such an RF signal is received from a wireless power receiver 103, the control circuit 210 can determine if the received signal includes a data communication component, a beacon component, or both. When a data communication component is present, the control circuit 210 may decode the communication portion of the signal and process the data. In some examples, the data provided by the communication portion of the signal may be system level monitoring data (e.g., energy storage level, etc.) or may be data related to the purpose or function of the rechargeable electronic device 102 having, or otherwise associated with, the wireless power receiver 103 (e.g., sensor data or data about an IoT device).

The control circuit 210 may determine a range and location of a client device, such as by performing phase data extraction from the beacon component. For example, the WPT 200 may implement a phase-based determination system such as described in U.S. Pat. No. 10,396,602 or U.S. Pat. No. 10,447,092, which are incorporated by reference herein in their entireties. Based on the range and location of the client, the control circuit 210 can establish a wireless power delivery to the wireless power receiver 103 via a dedicated, retrodirective linkage channel using one or more of the antennas 260A-260N. In some embodiments, a proxy antenna element 240 can broadcast the discovery signal to wireless power receiver(s) 103 within a certain range. As discussed herein, the discovery signal can indicate to a wireless power receiver 103 that wireless power delivery is available.

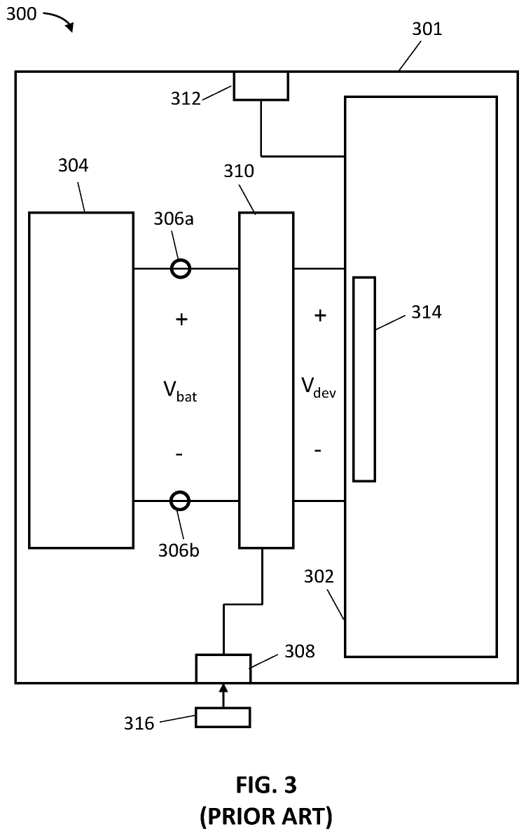

FIG. 3 depicts a circuit diagram of a rechargeable electronic device 300, in accordance with an embodiment known in the prior art. Various electrical and mechanical components may be at least partially positioned inside of an interior cavity defined by a housing 301. A circuit 302 and/or other electronic components of the rechargeable electronic device 300 may provide for and otherwise facilitate the provisions of functions for the benefit of users of device 300. For example, and without limitation, where rechargeable electronic device 300 is embodied in an electric toothbrush, circuit 302 may include at least one switch and a motor controller, and circuit 302 may be operatively coupled to a component 312 such as a DC motor to provide a torque to move a brush head of the electric toothbrush. As another example, where rechargeable electronic device 300 is embodied in a wireless audio speaker, circuit 302 may include at least one switch and a speaker driver, and circuit 302 may be operatively coupled to a component 312 such as a speaker to direct movements to mechanical parts of speaker by electromagnetic forces to produce audible sounds like music. To provide such functions for device 300, circuit 302 may include or otherwise be operatively coupled to a controller 314 that may be embodied in one or more of the types of components as described above with reference to FIG. 2 for the controller 210 of WPT 200.

Rechargeable electronic device 300 may include an energy storage device 304 at least partly positioned inside of the housing 301. Energy storage device 304 may be embodied in a rechargeable battery including, for example and without limitation, a Li-ion or an NiMH battery cell. Energy storage device 304 may be electrically coupled, or couplable to, a charging circuit 310 by way a ports 306 or similar connection means. When so connected, a voltage (V_{bat}) is induced between port 306a and port 306b. Charging circuit 310 may be operatively coupled to an input port 308 accessible from an exterior space of the housing 301. Input port 308 may be used to electrically couple charging circuit 310 to an external power supply 316 such as a wall outlet providing AC power at 60 Hz (or 50 Hz). In one embodiment, input port 308 may be a USB, USB-C or micro-USB design. In another embodiment, input port 308 may be a standard barrel male/female design. In any event, a user of device 300 may insert a suitable connector on one end of a power cord into port 308 and another end of the power cord into a plug with a transformer into a wall outlet, for example. The transformer may ultimately rectify and otherwise convert AC power into DC power to transmit a current at a predetermined voltage (e.g., 5V) from the external power supply 316 to the charging circuit 310. Charging circuit 310 may further convert and/or condition the DC power to another voltage (e.g., V_{bat} of 3.7-4.2V for Li-ion battery cell) for use in transmitting another current to charge the energy storage device 304. Charging circuit 310 may also convert and/or condition the DC power from external power supply 316 and/or energy storage device 304 to yet another voltage (e.g., V_{dev} of 3.3V) for use in transmitting yet another current to operate the circuit 302 and component(s) 312 coupled thereto. In some embodiments, the circuit 302 includes the charging circuit 310.

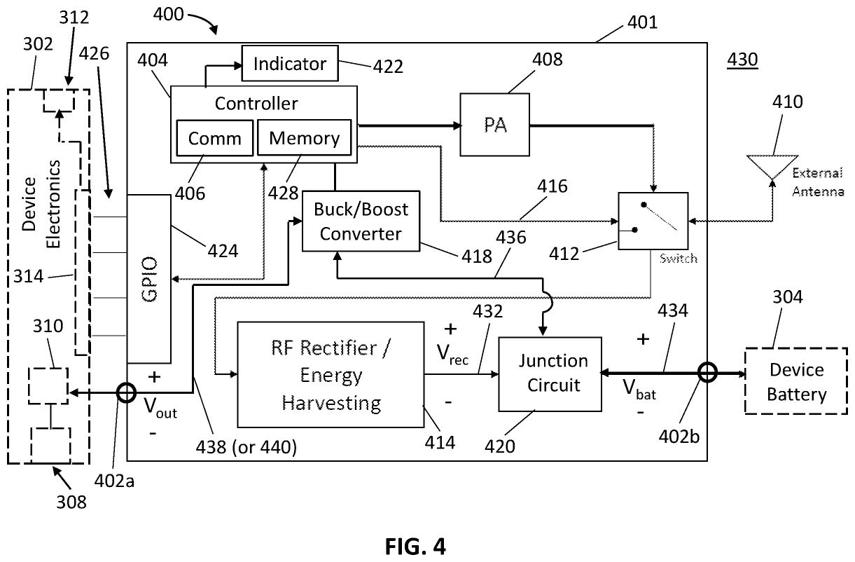

FIG. 4 is a circuit diagram of a wireless transceiver 400, in accordance with certain embodiments of the present disclosure. The wireless transceiver 400 includes a first circuit 401. First circuit 401 can be an example implementation of the wireless power receiver 103 shown and described above with reference to FIGS. 1 and 2. First circuit 401 is coupled, or couplable, to and between the energy storage device 304 and circuit 302 (also referred to herein as “second circuit”) of the rechargeable electronic device 300. Any suitable means for coupling the first circuit 401 to the second circuit 302 and the energy storage device 304 may be used for this purpose. For example, and without limitation, a first port 402a may be used to electrically couple first circuit 401 to the second circuit 302 and a second port 402b may be used to electrically couple first circuit 401 to the energy storage device 304.

In one embodiment, a means for alternately coupling and decoupling the wireless transceiver 400 to/from the second circuit 302 and the energy storage device 304 may be electrically coupled to the first and second ports 402a and 402b. For example, and without limitation, a switch (not shown) may be coupled to and between the first and second ports 402a and 402b and may be accessible by a user of device 300 from outside of the housing 301. In this example, a user of device 300 may thus selectively disable the functionality of the wireless transceiver 400, as during times when a WPT 200 is not available (e.g., when using a wireless speaker having wireless transceiver 400 at a remote campground where not WPT 200 exists).

This coupling of first circuit 401 to and between second circuit 302 and energy storage device 304 may be accomplished quickly and with little or no modification needed to existing circuitry of the rechargeable electronic device 302. Furthermore, at least a portion of the first circuit 401 may be formed as a flexible printed circuit board (PCB) to enable or otherwise facilitate conformance and fit into, for example, housings 301 of rechargeable electronic devices 300. Furthermore, first circuit 401 may or may not include an antenna 410 for the functionality of wireless transceiver 400, as described below. Antenna 410 may be integrated in or on first circuit 401, or it may be a separate component or module coupled, or couplable, to first circuit 401.

In some embodiments, an existing antenna of the rechargeable electronic device 300 may be utilized for at least some of the functionality of wireless transceiver 400 according to the present technology. However, some rechargeable electronic device 300 may have use their own existing antenna(s) for operations. To eliminate, or at least minimize, potential RF interference with the functions of the device 300, the antenna(s) 410 of the wireless transceiver 400 may be positioned sufficiently far away and “off board” from the first circuit 401. Furthermore, the wireless transceiver 400 may utilize wireless power signals that are sent by WPT 200 and received by first circuit 401 at an RF frequency that is sufficiently different from an operating RF frequency of the rechargeable electronic device 300. In stead of, or in addition to, having a wireless power signal frequency that is distinct from the device 300 operating frequency, RF interference may be eliminated or minimized through a time scheme whereby the device 300 transmits or receives any necessary wireless signals only during such times when the first circuit 401 is not receiving the wireless power signals from the WPT 200. In another example, the first circuit 401 may be controlled such that the energy storage device 304 is only charged using the wireless power signal when the rechargeable electronic device 300 is turned off.

As such, wireless transceiver 400 is well suited for either retrofitting into existing rechargeable electronic devices 300 or for integrating into new designs. Accordingly, the present technology may enable most any rechargeable electronic device 300 to advantageously utilize wireless charging. The inventor of the present technology believes that the wireless transceiver 400 and related technology disclosed herein will accelerate adaptation of wireless charging to both existing and new designs of rechargeable electronic devices 300 in a wide variety of technical and industrial fields and consumer application.

First circuit 401 may include, or be coupled, or couplable, to at least one antenna 410. The antenna 410 may be a dual-band antenna or may include more than one antenna. In some embodiments, the first circuit 401 may include a single antenna 410 (e.g., a dual-band antenna) that provides data transmission functionality as well as power and data reception functionality.

Antenna 410 is coupled, or couplable, to a switch 412. Switch is coupled to a controller 404 through two lines, as shown in FIG. 4. A state of switch 412 may be controlled by controller 404 by a control signal transmitted on a control line 416. Controller 404 may be embodied in one or more of the types of components as described above with reference to FIG. 2 for the controller 210 of WPT 200. In embodiments where controller 404 is or includes a computer, processor, microcontroller, and the like, controller 404 may include or be coupled, or couplable, to a memory storage device 428 (also referred to herein as memory 428). Memory 428 may include one or more non-transitory computer readable media (e.g., ROM, EEPROM and/or Flash-type) to store as, for example, firmware or software, program instructions executable by controller 404 for implementing, or otherwise enabling or facilitating, the processes and methods described herein according to the present technology.

The switch 412 in a first state couples antenna 410 to a power amplifier 408 that is in turn coupled to the controller 404. Controller 404 includes or is associated with or coupled to a communication module 406. The communications module 406 includes circuitry under control of controller 404 to generate an RF signal (e.g., beacon) for transmission using antenna 410 to a wireless power delivery environment 430 which may contain the WPT 200. The power amplifier 408 may amplify this RF signal to facilitate its transmission to environment 430 and thus also receipt by WPT 200. The switch 412 in a second state couples antenna 410 to a means 414 for inducing a voltage in response to the wireless power signal being received (e.g., an RF rectifier/energy harvester 414). With the switch 412 in the second state, the first circuit 401 utilizes antenna 410 to receive a wireless power signal transmitted by WPT 200 into environment 430. The wireless power signal passes from antenna 410 to the RF rectifier/energy harvester 414, which induces a voltage (V_{rec}) in response to the wireless power signal being received.

In some embodiments, the controller 404 and/or the communication module 406 can communicate with or otherwise derive device information (e.g., IoT information, client ID, or a power urgency indicator) from the rechargeable electronic device 300 in which transceiver 400 is embedded or otherwise associated with. Although not shown, in some embodiments, the wireless power receiver 300 can have one or more data connections (wired or wireless) with the device 300 by which the wireless transceiver 400 over which device information can be obtained. Such connections may include one or more ports 424 coupled to and between controller 404 and the controller 314 and/or at least a portion of the second circuit 302. Alternatively, or additionally, device 300 information can be determined or inferred by the controller 404, the first circuit 401 and/or other components of transceiver 400; for example, via one or more sensors (not shown in FIG. 4). The device information can include, but is not limited to, information about the capabilities of the device 300 with which the wireless transceiver 400 is associated, usage information of the device 300, power levels of the energy storage device(s) 304 of the device 300, information obtained or inferred by the device 300, or any combination thereof.

In some embodiments, a client identification (ID) module (not shown) can store a client ID that can uniquely identify the wireless transceiver 400 in the wireless power delivery environment 430. For example, the client ID can be transmitted to one or more wireless power transmission systems 200 when communication is established. In some embodiments, the wireless transceiver 400 may be able to receive and identify one or more other wireless transceivers 400 in the wireless power delivery environment 430 based on respective client IDs. Data representative of the client ID may be stored in memory 428 for use by the controller 404 and/or the communication module 406.

First circuit 401 may include a power converter 418 (e.g., buck/boost) and a junction circuit 420. The junction circuit 420 is coupled to the RF rectifier/energy harvester 414, the power converter 418, and the energy storage device 304 by way of the second port 402b. The power converter 418 is coupled to the controller 404 and the second circuit 302 by way of the first port 402a. When a wireless power signal is being received by the RF rectifier/energy harvester 414 of the first circuit 401 via the antenna 410, a DC current 432 is transmitted to junction circuit 420. The junction circuit 420 may contain circuitry to convert and/or condition the DC current 432 to, for example a DC current 434 at V_{bat} to charge the energy storage device 304.

In addition to, or instead of, the DC current 424 being transmitted from the junction circuit 420 to the energy storage device 304, junction circuit 420 may relay a DC current 436 at V_{bat} (or another voltage) to the power converter 418. The power converter 418 may contain circuitry to convert and/or condition the DC current 436 to, for example a DC current 438 at Vₒᵤₜ (or another voltage) for use by the second circuit 302, as described above with reference to FIG. 3. In the illustrated embodiment, controller 404 is coupled to the power converter 418. Controller 404 may thus sense and measure the Vₒᵤₜ and accordingly adjust parameters (e.g., a switching frequency) of power converter 418 so as to maintain Vₒᵤₜ at a predetermined voltage or within a predetermined range of voltages. Similarly, with power converter 418 coupled to first port 402a and controller 404, controller 404 may also determine that second circuit 302 is receiving a current 440 via input port 308.

In other embodiments, the junction circuit 420 may include at least some of the components and functionality of the power converter 418, and the controller 404 may instead be operably coupled to the junction circuit 420. In such examples, the controller 404 may sense and measure the Vₒᵤₜ and/or the V_{bat} and accordingly adjust parameters (e.g., switch frequency) of junction circuit 420 so as to maintain Vₒᵤₜ and/or the V_{bat} at respective predetermined voltage(s) or within respective predetermined range(s) of voltages. Likewise, in the example, with junction circuit 420 coupled to first port 402a and controller 404, controller 404 may then determine that second circuit 302 is receiving the current 440 via input port 308.

The wireless transceiver 400 may also include a means 422 coupled to controller 402 for indicating to a user of the rechargeable electronic device 300 that the wireless power signal is being received by the first circuit 401. The means 422 may include, or be embodied in, an LED light 422 that is visible to the user from the exterior of the housing 301 of device 300. The means 422 may be included on or in the first circuit 401, or means 422 may be coupled, or couplable, to the first circuit 401. In one embodiment, the LED light 422 may be energized (e.g., illuminated) when the wireless power signal is being received by the first circuit 401 and the LED light 422 may be deenergized (e.g., not illuminated) when the wireless power signal is not being received by the first circuit 401. In another embodiment, the LED light 422 may be energized and illuminated in a first color (e.g., green) when the wireless power signal is being received by the first circuit 401 and the LED light 422 may be energized and illuminated in a second color (e.g., orange) when the wireless power signal is not being received by the first circuit 401.

The wireless transceiver 400 may further include a means 424 coupled to controller 402 for interfacing at least a portion of the wireless transceiver 400 (e.g., controller 404 and/or component(s) of first circuit 401) with at least a portion of another circuit (e.g., controller 314 and/or component(s) of second circuit 302). The means 424 may include, or be embodied in, one or more general purpose input/output (GPIO) port(s) 424. The means 424 may be included on or in the first circuit 401, or means 424 may be coupled, or couplable, to the first circuit 401. In one embodiment, component 312 of device 300 may include similar functionality of indicator 422, as described above. In such embodiments, and instead of or in addition to using indicator 422, component 312 may include at least one LED light to indicate to the user whether or not the wireless power signal is being received by the first circuit 401. In another embodiment, the charging circuit 310 may be operably coupled to, and under the control of, controller 314. In this embodiment, controller 404 may be coupled to controller 314 by way of at least one of the GPIO ports 424. Controller 404 may transmit a control signal to controller 314 to direct controller 314 to alternately enable and disable at least a portion of the functionality of the charging circuit 310.

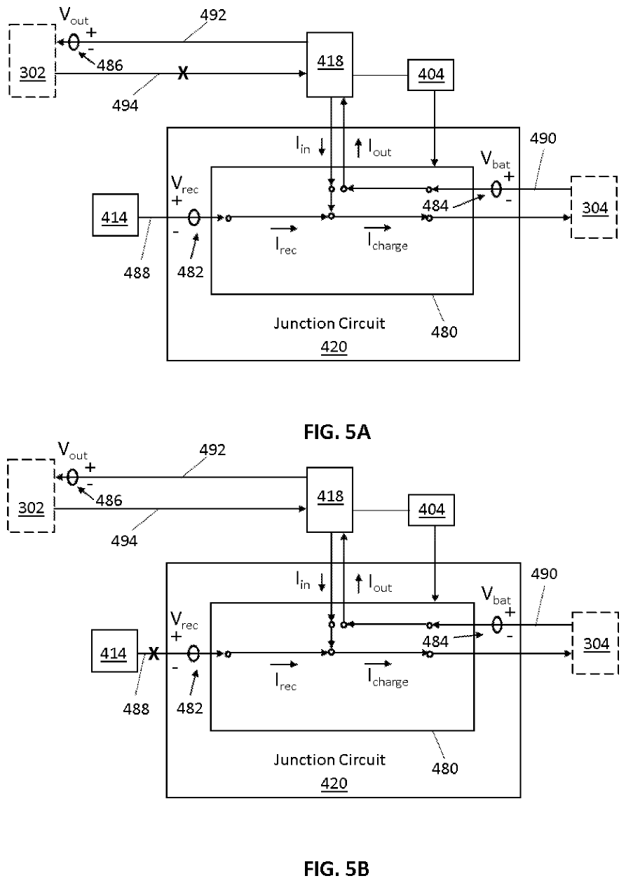

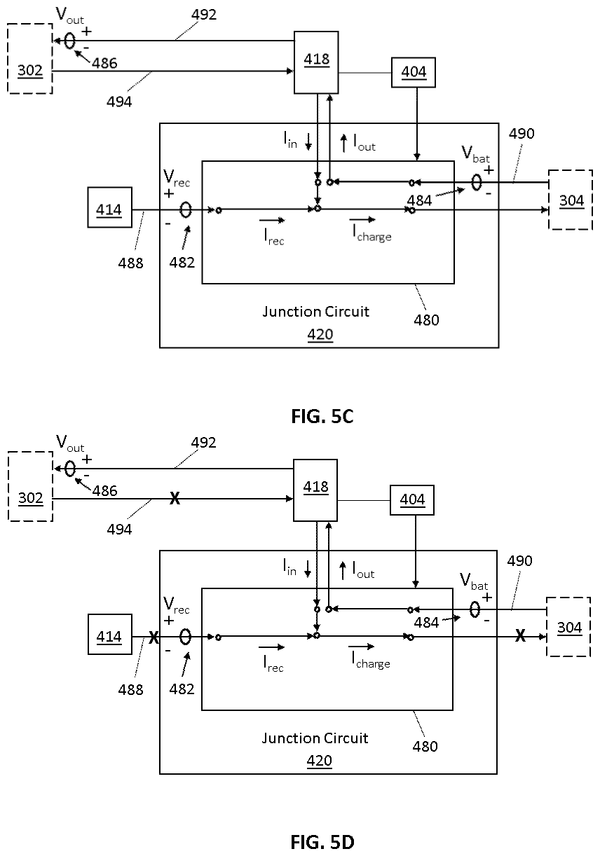

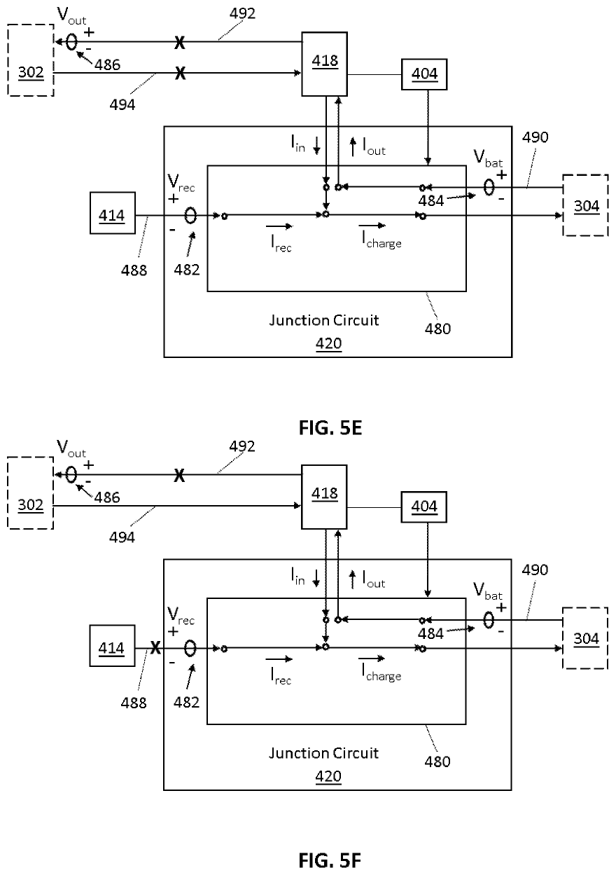

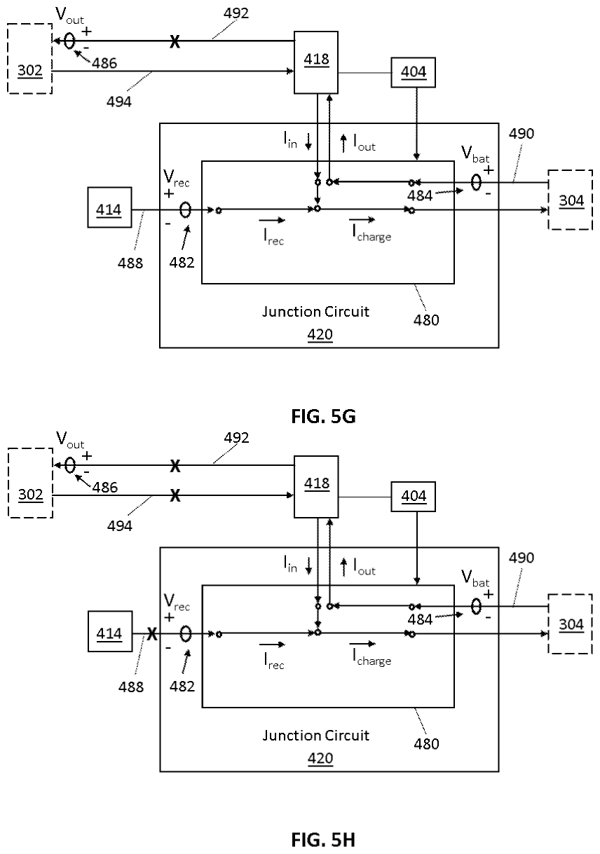

FIGS. 5A-5H are circuit diagrams of a junction circuit (e.g., circuit 420) that may be used with the wireless transceiver (e.g., first circuit 401) shown in FIG. 4, and operational states thereof, in accordance with certain embodiments of the present disclosure. Junction circuit 420 may include a plurality of switchable nodes 480, where switched states of such nodes are controllable by control signals transmitted to circuit 420 by controller 404. Junction circuit 420 may also include one or more digital and/or analog voltmeters (482, 484 and/or 486), one or more of which may be operatively coupled to controller 404 to receive signals encoding data representative of one or more of V_{rec}, V_{bat}, and Vₒᵤₜ. In the larger context of first circuit 401, junction circuit 420 lies at an intersection of lines of electric power flow, which may have differing voltages. The voltages of various lines shown, for example and without limitation, in FIGS. 5A-5H as lines 488, 490, 492 and 494, may, at least in part, form the basis for control by controller 404 of switched states of the various switchable nodes 480 of junction circuit 420. In other embodiments, control of nodes 480 may not rely on control signals from controller 420 and may instead, or additionally, be automated according to feedback receiver directly from voltmeters 482, 484 and/or 486. In FIGS. 5A-5H, an absence of current flowing in a line is denoted by an “X”.

Referring to FIG. 5A, a first operational state of junction circuit 420 may exist where RF rectifier/energy harvester 414 transmits a current (I_{rec}) at V_{rec} on line 488 as a result of receipt of wireless power, as described above with reference to FIG. 4. In the first operational state, device 302 does not provide an additional current (Iᵢₙ) on line 494 for use in charging energy storage device 304 (e.g., device battery). Accordingly, a current (I_{charge}) flowing to battery 304 is equal to I_{rec}. A current Iₒᵤₜ at V_{bat} may be provided on line 490 to device electronics (e.g., second circuit 302) for its operation.

Referring to FIG. 5B, a second operational state of junction circuit 420 may exist where RF rectifier/energy harvester 414 does not transmit I_{rec} at V_{rec} on line 488 because wireless power is not being received. In the second operational state, second circuit 302 may be receiving power via input port 308 for use in charging battery 304. In this case, current Iᵢₙ may flow on line 494 for use in charging battery 402. Accordingly, current I_{charge} flowing to battery 304 is equal to Iᵢₙ. Current Iₒᵤₜ at V_{bat} may be provided on line 490 to second circuit 302 for operation of the device electronics.

Referring to FIG. 5C, a third operational state of junction circuit 420 may exist where both RF rectifier/energy harvester 414 and second circuit 302 both provide currents (Iᵢₙ on line 494 and I_{rec} on line 488, respectively) for use in charging energy storage device 304. Accordingly, current I_{charge} flowing to battery 304 is equal to Iᵢₙ plus I_{rec}. Current Iₒᵤₜ at V_{bat} may be provided on line 490 to second circuit 302 for operation of the device electronics.

Referring to FIG. 5D, a fourth operational state of junction circuit 420 may exist where neither RF rectifier/energy harvester 414 nor second circuit 302 provide currents Iᵢₙ and I_{rec} for use in charging energy storage device 304. Accordingly, current I_{charge} does not flow to battery 304 in the fourth operational state of junction circuit 420. Current Iₒᵤₜ at V_{bat} may be provided on line 490 to second circuit 302 for operation of the device electronics and a state of charge of energy storage device 304 will thus be depleted during such times when currents Iᵢₙ and I_{rec} are not flowing in junction circuit 420.

Referring to FIG. 5E, a fifth operational state of junction circuit 420 may exist where RF rectifier/energy harvester 414 transmits current I_{rec} at V_{rec} on line 488 as a result of receipt of wireless power, but no current Iᵢₙ flows on line 494 from second circuit 302 to provide additional current for charging energy storage device 304. In the fifth operational state, the electronic device with second circuit 302 may be powered off or in a state (e.g., sleep mode) requiring reduced power consumption as compared to being in a powered on state. Accordingly, current I_{charge} flowing to battery 304 is equal to I_{rec}, and current Iₒᵤₜ is zero or a negligible amount as compared to when second circuit 302 draws the required amperage at V_{bat} from line 490.

Referring to FIG. 5F, a sixth operational state of junction circuit 420 may exist where RF rectifier/energy harvester 414 does not transmit current I_{rec} at V_{rec} on line 488, but current Iᵢₙ does flow on line 494 from second circuit 302 to provide additional current for charging energy storage device 304. In the sixth operational state, the electronic device with second circuit 302 may be powered off or in a state (e.g., sleep mode) requiring less power consumption as compared to when it is powered on. Accordingly, current I_{charge} flowing to battery 304 is equal to Iᵢₙ, and current Iₒᵤₜ is zero or a negligible amount as compared to when second circuit 302 draws the required current at V_{bat} from line 490.

Referring to FIG. 5G, a seventh operational state of junction circuit 420 may exist where both RF rectifier/energy harvester 414 and second circuit 302 transmit currents I_{rec} and Iᵢₙ on lines 488 and 494, respectively, to facilitate charging of energy storage device 304. In the seventh operational state, the electronic device with second circuit 302 may be powered off or in a state (e.g., sleep mode) requiring less power consumption as compared to when it is powered on. Accordingly, current I_{charge} flowing to battery 304 is equal to I_{rec} plus Iᵢₙ, and current Iₒᵤₜ is zero or a negligible amount as compared to when second circuit 302 draws the required current at V_{bat} from line 490.

Referring to FIG. 5H, an eighth operational state of junction circuit 420 may exist where neither RF rectifier/energy harvester 414 nor second circuit 302 transmit currents I_{rec} and Iᵢₙ, on lines 488 and 494, respectively, to facilitate charging of energy storage device 304. In the eighth operational state, the electronic device with second circuit 302 may be powered off or in a state (e.g., sleep mode) requiring less power consumption as compared to when it is powered on. Accordingly, currents Iₒᵤₜ, I_{charge} and Iᵢₙ are all zero.

In the embodiments illustrated in FIGS. 5A-5H, Iₒᵤₜ is first transmitted from junction circuit 420 to power converter 418 such that V_{bat} may be changed to Vₒᵤₜ on line 492 as needed for subsequent transmission to second circuit 302. In the other embodiments, as for example where V_{bat} and Vₒᵤₜ required by second circuit 302 are equal, or within a specified tolerance of one another, first circuit 401 may not include power converter 418.

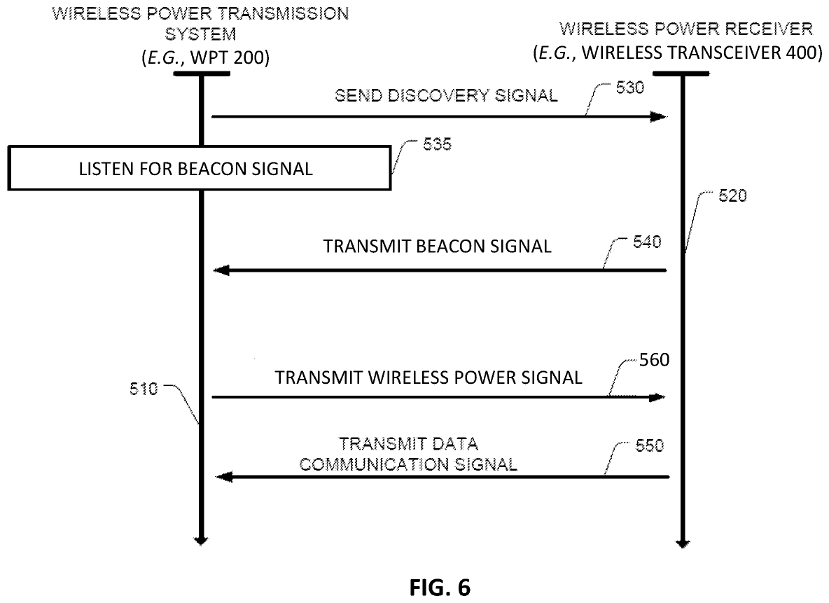

FIG. 6 is a sequence diagram illustrating example operations between a wireless power transmission system (e.g., WPT 200) and a wireless transceiver (e.g., wireless transceiver 400), in accordance with certain embodiments of the present disclosure. Initially, communication can be established between the WPT 510 and the wireless transceiver 520 via a discovery signal 530. The discovery signal 530 may be a pulse interval modulated signal that can provide power to the wireless transceiver 520. Then, at 535, the WPT 510 may listen for a response from the wireless transceiver 520, which may include monitoring for an RF signal such as a beacon signal.

Once the wireless transceiver 520 receives the discovery signal, the wireless transceiver 520 may send back the RF (e.g., beacon) signal (at 540), a data communication signal (at 550), or both, depending on the charge level or other operational status of the energy storage device 304. The WPT 510 may receive the transmitted signal(s) from the wireless transceiver 520 and, in response thereto, transmit (at 560) a wireless power signal to the wireless transceiver 520. In some embodiments, the data communication signal 550 may be sent to the WPT 510 after the wireless power signal has been transmitted to the wireless transceiver 520, as shown in FIG. 6. The wireless power signal 560 may be provided via retrodirective linkage at a first band and the data communication signal may be provided at a second band, which both may be sent or received via a dual-band antenna (e.g., antenna 410). The wireless power signal 560 may be based on a range and location determined from the beacon signal 540 by the WPT 510.

The WPT 510 can receive the beacon signal 540 from the wireless transceiver 520 and detect, or otherwise measure, the phase (or direction) from which the signal is received at multiple antennas 410. In some embodiments, the WPT 510 can determine the complex conjugate of the measured phase of the beacon signal 540 and can use the complex conjugate to determine a transmit phase to configure the antennas 410 for delivering or otherwise directing the transmission of the wireless power signal(s) to the wireless transceiver 520.

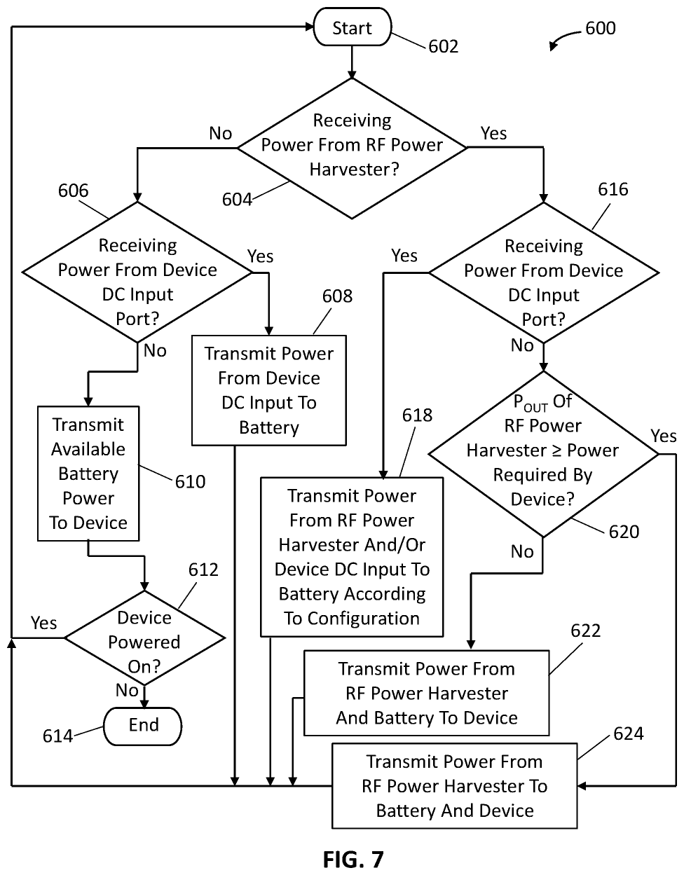

FIG. 7 is a state diagram of a process 600 for operating a wireless transceiver (e.g., wireless transceiver 400), in accordance with certain embodiments of the present disclosure. Process 600 may be implemented by the transceiver 400 and the various components thereof, as described herein according to the present technology. Process 600 may begin at a start state 602 whereby a rechargeable electronic device 300 having the wireless transceiver 400 coupled to and between its energy storage device 304 and its second circuit 302 is initially powered on. In some embodiments, the process 600 may alternatively or additional commend even during such times that device 300 is powered off.

From the start state 602, process 600 may proceed to a logic branch 604 in which controller 404 determines whether or not the wireless power signal is being received by the RF rectifier/energy harvester 414. If, for purposes of logic branch 604, the wireless power signal is not being received by the RF rectifier/energy harvester 414, then process 600 may proceed to a logic branch 606. In logic branch 606, controller 404 may determine whether or not DC power is being received via the input port 308 of the rechargeable electronic device 300. If, for purposes of logic branch 606, DC power is not being received at the input port 308, then process 600 may proceed to an operation 610. In operation 610, the controller 610 may cause the first circuit 401 to transmit available battery power from the energy storage device 304 to the second circuit 302 via the first and second ports 402a and 402b. From operation 610, process 600 may proceed to a logic branch 612 in which controller 404 may determine whether or not the rechargeable electronic device 300 is powered on. In one embodiment, if, for purposes of logic branch 612, controller 404 determines that the device 300 is powered on, process 600 may loops back to the start state 602; otherwise process 600 may proceed to an end state 614. In another embodiment, process 600 may not include logic branch 612 and end state 612, and process 600 may instead loops back to the start state 602 from operation 610 regardless of whether or not the rechargeable electronic device 300 is powered on.

If, for purposes of logic branch 606, DC power is being received at the input port 308, then process 600 may proceed to an operation 608. In operation 608, the controller 610 may cause the first circuit 401 to transmit DC power from the input port 308 to the energy storage device 304 via the first and second ports 402a and 402b. From operation 608, process 600 may loop back to the start state 602.

If, for purposes of logic branch 604, the wireless power signal is being received by the RF rectifier/energy harvester 414, then process 600 may proceed to a logic branch 616. In logic branch 616, the controller 404 may determine whether or not DC power is being received via the input port 308 of the rechargeable electronic device 300. If, for purposes of logic branch 616, DC power is being received at the input port 308, then process 600 may proceed to an operation 618. In operation 618, the controller 610 may cause the first circuit 401 to transmit DC power from at least one of the RF rectifier/energy harvester 414 and the input port 608 to the energy storage device 304.

In one embodiment, and for purposes of operation 618, whether DC power is transmitted one or both of the RF rectifier/energy harvester 414 and the input port 608 is dictated by at least one user configuration setting, which may be stored in the memory 428 for use by controller 404. In an example, the configuration setting(s) may be stored in memory 428 for use by controller 404 prior to installation of wireless transceiver 400 to and between second circuit 302 and energy storage device 304 of the rechargeable electronic device 300. In another example, the configuration setting(s) may be stored in memory 428 for use by controller 404 after the wireless transceiver 400 is installed to and between second circuit 302 and energy storage device 304 of the rechargeable electronic device 300. In such examples, the configuration setting(s) may be changed from time to time as by a means (not shown) for transmitting data from outside the housing 301 to be stored in memory 428. From operation 618, process 600 may loop back to the start state 602.

If, for purposes of logic branch 616, DC power is not being received at the input port 308, then process 600 may proceed to a logic branch 620. In logic branch 620, the controller 404 may determine whether or not a DC output power (e.g., Pₒᵤₜ at V_{rec}) of the RF rectifier/energy harvester 414 is greater than or equal to (or alternatively greater than) a DC power required by the second circuit 302 of the rechargeable electronic device 300. If, for purposes of logic branch 620, the DC output power of the RF rectifier/energy harvester 414 is greater than or equal (or alternatively greater than) to a DC power required by the second circuit 302 of the device 300, then process 600 may proceed to an operation 624. In operation 624, the controller 610 may cause the first circuit 401 to transmit DC power from the RF rectifier/energy harvester 414 to both the second circuit 302 and the energy storage device 304. From operation 624, process 600 may loop back to the start state 602.

If, for purposes of logic branch 620, the DC output power of the RF rectifier/energy harvester 414 is less than (or alternatively less than or equal to) the DC power required by the second circuit 302 of the device 300, then process 600 may proceed to an operation 622. In operation 622, the controller 610 may cause the first circuit 401 to transmit DC power from both the RF rectifier/energy harvester 414 and the energy storage device 304 to the second circuit 302. From operation 624, process 600 may loop back to the start state 602.

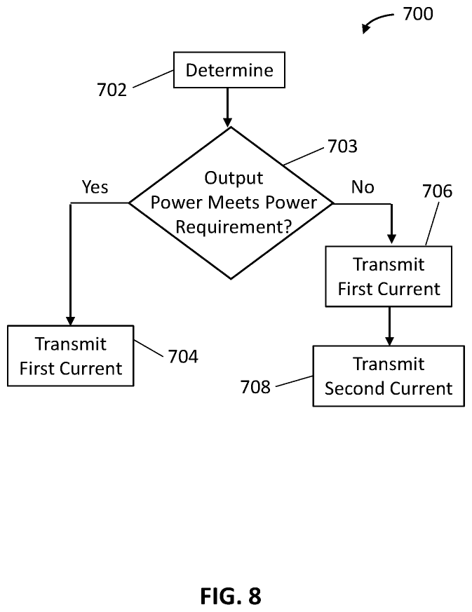

FIG. 8 is a flowchart of a method 700 of operating a wireless transceiver (e.g., wireless transceiver 400), in accordance with certain embodiments of the present disclosure. Method 700 may be implemented by the transceiver 400 and the various components thereof, as described herein according to the present technology. Method 700 may include the step of determining 702 (e.g., by the controller 404 and/or the first circuit 401), whether or not an output power associated with a voltage (e.g., V_{rec}) induced in response to the first circuit 401 receiving the wireless power signal is greater than or equal to a power requirement of the device 300 (e.g., the second circuit 302 thereof) coupled to the first circuit 401.

Depending on a result determined 403 by, for example controller 404, in the determining step 702, method 700 may proceed to two alternative steps. For determining 702 that the aforementioned output power is greater than or equal to (e.g., meets) the power requirement of the device 300, method 700 may include the step of transmitting 704 a first current from the first circuit 401 to the second circuit 302 and the energy storage device 304 coupled to the first circuit 401. Alternatively, for determining 702 that the aforementioned output power is less than (e.g., does not meet) the power requirement of the device 300, method 700 may include the steps: of transmitting 706 a second current from the first circuit 401 to the second circuit 302; and transmitting 708 a third current from the energy storage device 304 to the second circuit 302. In some embodiments, the two transmitting steps 706 and 708 may be performed sequentially in method 700. In other embodiments, the two transmitting steps 706 and 708 may be performed concurrently in method 700.

Method 700 may include various additional steps for purposes of facilitating steps 702, 704 and 706, as described above. Method 700 may include the step of transmitting 708 (e.g., by the first circuit 401 via antenna(s) 410 in a transmit mode), an RF (e.g., beacon) signal to the WPT 200. Method 700 may also include the step of receiving 710 (e.g., by the first circuit 401 via the antenna(s) 410 in a receive mode), the wireless power signal from WPT 200. In some embodiments of method 700, the wireless power signal may be received 710 by the wireless transceiver 400 from the WPT 200 in response to the RF signal being transmitted 708 by the wireless transceiver 400 to the WPT 200. In an example, method 700 may also include the step of energizing 711 a visual indicator (e.g., LED light 422) in response to receiving 710 the wireless power signal.

Method 700 may additionally include the step of inducing 712 (e.g., by the RF rectifier/energy harvester 414 of the first circuit 401), the voltage in response to receiving 710 the wireless power signal (e.g., via the antenna(s) 410). In some embodiments, the inducing 712 step of method 700 may include inducing 714 a first voltage. In an example, the method 700 may further include the step of converting 716 (e.g., by the power converter 418 of the first circuit 401) the first voltage to a second voltage after the inducing 714 step.

In an embodiment, method 700 may also include the step of determining 718 (e.g., by the controller 404 and/or the first circuit 401) that the second circuit 302 is receiving a fourth current from an external power supply (e.g., via input port 308). In the embodiment, for the fourth current being received by the second circuit 302, method 700 may include the step of receiving 720 (e.g., by the first circuit 401), the fourth current from the second circuit 302. After the fourth current is received 720 by the first circuit 401 in method 700, the fourth current may then by transmitted 722 by the first circuit 401 to the energy storage device 304.

Method 700 may further include the step of apportioning 724 DC currents to and from the second circuit 302, the energy storage device 304, and the RF rectifier/energy harvester 414 of the first circuit 401. In one embodiment, the apportioning 724 step of method 700 may include apportioning the aforementioned fourth current, and at least one of the aforementioned first, second, and third currents, for transmission and/or receipt to/from the second circuit 302 and the energy storage device 304. In method 700, the apportioning 724 step may be implemented (e.g., at least in part by controller 404) according to the aforementioned configuration setting(s) of the first circuit 401, which may be stored in memory 428. One or more of the various apportioned 724 DC currents may be associated with voltage(s) that are different from voltage(s) of one or more other apportioned 724 DC currents.

Referring again to FIGS. 4 and 7, in some embodiments, the circuitry of the junction circuit 420 of the first circuit 401 may, at least in part, implement the required functionality for the apportioning 724 step in method 700. As shown in FIG. 4, the junction circuit 420 lies at an intersection of lines of electric power flow in first circuit 401. With first circuit 401 coupled to and between the second circuit 302, and the energy storage device 304, of the rechargeable electronic device 300, the junction circuit 420 can receive and relay currents from the three sources of electric power: the input port 308, the energy storage device 304, and the RF rectifier/energy harvester 414 of the first circuit 401. Accordingly, the junction circuit 420 may, in conjunction with functions provided by the controller 404 and/or the power converter 418, apportion 724 various DC current flows for use in charging energy storage device 304, powering the second circuit 302, and providing any necessary power for components of the first circuit 401 such as the controller 404.

The above described structures and functions related to the apportioning 724 step further enable an emulating 726 step in method 700. With the wireless transceiver 400 with its first circuit 401 coupled to and between the second circuit 302 and the energy storage device 304, the first circuit 401 emulates 726 the energy storage device 304 to the second circuit 302. For example, and without limitation, controller 404 may, in conjunction with various other first circuit 401 components like the power converter 418 and the junction circuit 420, maintain the Vₒᵤₜ of the first circuit within a predetermined tolerance of the V_{bat} for which the rechargeable electronic device 300 was initially designed to operate with. This feature of the present technology in particular, among others, enables the wireless transceiver 400 to be retrofitted into most any rechargeable electronic device 300 to thereby effectively providing wireless charging capability using wireless power signals from one or more WPTs 200, and without the need for altering existing circuitry or software/firmware of the device 300. For the same or similar reasons, the wireless transceiver 400 of the present technology may be effectively and efficiently integrated de novo into new designs of most any rechargeable electronic device 300 to enable operation and charging using wireless power signals.

Accordingly, instead of an available power level for the rechargeable electronic device 300 being dictated solely by the availability of DC power from the energy storage device 304 and/or the input port 308, the present technology and associated devices, processes and methods enable at least a third source of DC power (e.g., from the RF rectifier/energy harvester 414) to be available to device 300 for its operation and/or for charging its energy storage device 304.

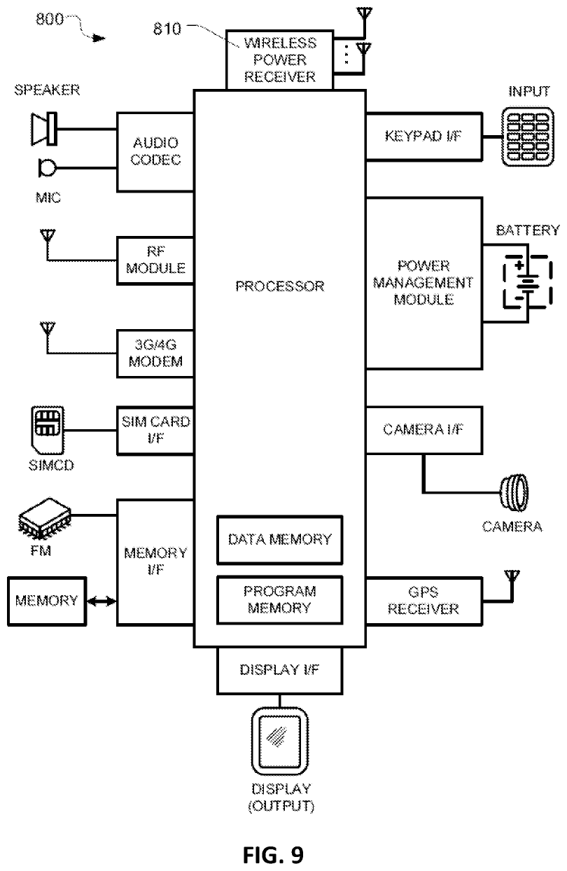

FIG. 9 depicts a block diagram of a computing device 800 with a wireless power receiver 810, in accordance with certain embodiments of the present disclosure. Computing device 800 includes any form of a computer with a wireless power receiver 810, such as a mobile (or smart) phone, tablet computer device, desktop computer device, laptop computing device, wearable computing device, or any other computing device for which wireless power charging could be applicable, in accordance with various embodiments herein. The wireless power receiver 810 may be implemented as the wireless transceiver 400, the first circuit 400, the controller 404, or any combination thereof. Further, wireless power receiver 810 may execute and perform any of the methods and functions described herein according to the present technology and with reference to the wireless transceiver 400 and the various components thereof.

Various interfaces and modules are shown in or coupled to the computing device 800; however, computing device 800 does not require all of such modules or functions for performing the functionality described herein. It is appreciated that, in many embodiments, various components are not included or necessary for operation of the respective computing device. For example, components such as global positioning system (GPS) radios, cellular radios, SIM cards, cameras, and accelerometers, as well as other components, may not be included in some implementations of a computing device. Further, one or more of the components or modules shown may be combined or removed.

For example, with the wireless power receiver 810 implemented, the battery, power management module, or both may be redundant in some embodiments, such as if all power management functions for the computing device 800 are built into the wireless power receiver 810. Further, a battery might not be necessary in embodiments that receive constant power via the wireless power receiver 810.

The embodiments of the present technology as shown, described and claimed herein provide circuitry and control schemes therefor provide at least the following advantageous technical effects: (a) a wireless transceiver that may be either retrofitted into existing rechargeable electronic devices, or integrated de novo into new designs, to enable radio frequency (RF) wireless power signals to be used for operation and battery charging; (b) the wireless transceiver includes a circuit that can receive, relay, and apportion currents from multiple different DC electric power sources—including ones derived from wireless power signals—for use in operating the rechargeable electronic device and charging its battery or batteries; (c) a wireless transceiver that may be powered by either the existing power sources used by the rechargeable electronic device, or additionally or instead by wireless power signals; (d) a wireless transceiver having a size that may facilitate insertion into housings of existing rechargeable electronic devices and which may be formed, at least in part, as a flexible printed circuit board (PCB); (e) a wireless transceiver having circuitry controlled such that the wireless transceiver coupled to and between circuit(s) of the rechargeable electronic device and at least one battery thereof emulates the at least one battery with no requirement for modification of either the existing circuit(s) or battery(ies) of the device, and existing software or firmware of the device; and (f) such other(s) that may be readily understood and appreciated, upon study of the present disclosure, by persons having ordinary skill in the art.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments can be made, and other embodiments not specifically described herein will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A method comprising:
determining, by a first circuit, whether or not an output power associated with a voltage induced in response to the first circuit receiving a wireless power signal is greater than or equal to a power requirement of a second circuit coupled to the first circuit; and
for determining the output power to be greater than or equal to the power requirement, transmitting a first current from the first circuit to the second circuit and an energy storage device coupled to the first circuit;
or
for determining the output power to be less than the power requirement:
transmitting a second current from the first circuit to the second circuit; and
transmitting a third current from the energy storage device to the second circuit.

2. The method of claim 1 further comprising determining, by the first circuit, that the second circuit is receiving a fourth current from an external power supply.

3. The method of claim 2 further comprising:
receiving, by the first circuit, the fourth current from the second circuit; and
transmitting, by the first circuit, the fourth current to the energy storage device.

4. The method of claim 3 further comprising apportioning, according to one or more configuration settings of the first circuit, the fourth current, and at least one of the first, second, and third currents, for transmission to the second circuit and the energy storage device.

5. The method of claim 1 further comprising:
inducing, by the first circuit, a first voltage in response to receiving the wireless power signal; and
converting the first voltage to a second voltage after the inducing.

6. The method of claim 1 further comprising:
transmitting, by the first circuit, a radio frequency (RF) signal to the WPT; and
receiving, by the first circuit, the wireless power signal from a wireless power transmitter (WPT) in response to transmitting the RF signal to the WPT.

7. The method of claim 1 further comprising emulating, by the first circuit, the energy storage device to the second circuit.

8. An apparatus comprising:
a circuit configured to:
receive a wireless power signal; and
induce a voltage in response to the circuit receiving the wireless power signal; and
a controller coupled to the circuit, wherein the controller is configured to:
determine whether or not an output power associated with the induced voltage is greater than or equal to a power requirement of another circuit for coupling to the circuit; and
for the output power being determined to be greater than or equal to the power requirement, cause a first current to be transmitted from the circuit to the another circuit and an energy storage device for coupling to the circuit;
or
for the output power being determined to be less than the power requirement:
cause a second current to be transmitted from the circuit to the another circuit; and
cause a third current to be transmitted from the energy storage device to the another circuit.

9. The apparatus of claim 8, wherein the controller is further configured to:
determine that the another circuit is receiving a fourth current from an external power supply; and
cause the fourth current to be transmitted to the energy storage device.

10. The apparatus of claim 9, wherein the controller is further configured to cause, according to one or more configuration settings of the circuit, the fourth current, and at least one of the first, second, and third currents, to be apportioned for transmission to the another circuit and the energy storage device.

11. The apparatus of claim 8, wherein the circuit further comprises:
means for inducing the voltage as a first voltage in response to receiving the wireless power signal; and
means for converting the first voltage to a second voltage.

12. The apparatus of claim 8 further comprising a visual indicator configured to be energized in response to the wireless power signal being received by the circuit.

13. The apparatus of claim 8 further comprising an antenna for coupling to the circuit and configured to receive the wireless power signal from a wireless power transmitter (WPT).

14. The apparatus of claim 13 further comprising means for transmitting a radio frequency (RF) signal to the WPT.

15. The apparatus of claim 14 further comprising means coupled to the controller for switching the antenna between a receive mode and a transmit mode.

16. The apparatus of claim 8 further comprising one or more input/output ports coupled to the controller for interfacing with at least a portion of the another circuit.

17. The apparatus of claim 8 further comprising means for emulating the energy storage device to the another circuit.

18. The apparatus of claim 8, wherein at least a portion of the circuit is formed as a flexible printed circuit board.

19. The apparatus of claim 8 further comprising means for coupling the circuit to the second circuit and the energy storage device.

20. One or more non-transitory computer readable media having stored thereon program instructions which, when executed by at least one processor, cause a machine to:
determine whether or not an output power associated with a voltage induced in response to a first circuit receiving a wireless power signal is greater than or equal to a power requirement of a second circuit coupled to the first circuit; and
for the output power determined to be greater than or equal to the power requirement, cause the first circuit to transmit a first current to the second circuit and an energy storage device coupled to the first circuit;
or
for the output power determined to be greater than or equal to the power requirement, cause the first circuit to:
transmit a second current to the second circuit; and
transmit a third current from the energy storage device to the second circuit.
